(19) United States
(12) Patent Application Publication
(10) Pub. No.: US 2024/0428129 A1
(43) Pub. Date: Dec. 26, 2024

(54) Asset Operating State Analyzer

(71) Applicant: Aspen Tech Corporation, Bedford, MA (US)

(72) Inventor: Jiangsheng You, Andover, MA (US)

(21) Appl. No.: 18/341,146

(22) Filed: Jun. 26, 2023

(51) Int. Cl. G06N 20/00

(52) U.S. Cl. CPC G06N 20/00

(57) ABSTRACT

Embodiments analyze an operating state of a physical asset. An embodiment first acquires, based on one or more predetermined criteria, data measurements from one or more preselected sensors configured to sense one or more respective aspects of the physical asset. The data measurements correspond to one or more time periods, the one or more preselected sensors are preselected by correlating data measurements from a plurality of sensors of the physical asset to one or more operating states of the physical asset, and the one or more predetermined criteria are predetermined by identifying one or more data output patterns of the one or more preselected sensors. Then, via a first model, one or more operating states of the physical asset are determined based on the acquired data measurements.

### BACKGROUND

Physical asset lifecycle management, such as for heavy industrial assets, includes, for example, asset planning, asset commissioning, asset operation, asset maintenance, and asset decommissioning. One aspect of managing physical asset lifecycles is asset performance management (APM).

### SUMMARY

Existing approaches for APM are inadequate because, among other drawbacks, they are unable to determine or predict an asset operating state. Thus, functionality capable of determining or predicting a physical asset operating state is needed. Embodiments disclosed herein provide such functionality.

Specifically, some embodiments of the present disclosure offer a novel method and corresponding system to address several problems in the optimization of physical asset life operation by using machine learning (ML) methodologies. For example, some embodiments use ML methodologies to provide a model to describe an optimized state to improve automation. Some embodiments improve comprehension of ML results by providing a single index to measure a deviation of asset operation from its optimized state. Some embodiments provide a scaled feature distance method to report leading parameters that contribute to an underlying problem.

In some embodiments, a computer-implemented method is disclosed for analyzing an operating state of a physical asset. In one such embodiment, the method acquires, based on predetermined criterion or criteria, data measurements from preselected sensor(s) configured to sense respective aspect(s) of the physical asset. According to an embodiment, the data measurements correspond to time period(s), the preselected sensor(s) are preselected or grouped by correlating data measurements from multiple sensors of the physical asset to operating state(s) of the physical asset, and the predetermined criterion or criteria are predetermined by identifying data output pattern(s) of the preselected sensor(s). In an example embodiment, the method then determines, via a first model, operating state(s) of the physical asset based on the acquired data measurements.

In some embodiments, the first model includes a machine learning model, a dimensionality reduction model, or a clustering model. According to one such embodiment, the clustering model can be a statistical model or an analytical model. Further, in yet another embodiment, the dimensionality reduction model includes a principal component analysis (PCA) model, a restricted Boltzmann machine (RBM) model, a t-distributed stochastic neighbor embedding (t-SNE) model, and/or a uniform manifold approximation and projection (UMAP) model. According to an embodiment, the clustering model includes a self-organizing map (SOM) model, a mixture model, a local outlier factor (LOF) model, and/or a density-based model.

In some embodiments, the first model is configured, based on training data, with operating state template(s). In one such embodiment, determining, via the first model, the operating state of the physical asset based on the acquired data measurements includes correlating the acquired data measurements with the operating state template(s). According to another embodiment, the training data includes domain-specific information and one of the operating state template(s) is based, at least in part, on the domain-specific information.

In an embodiment, the method further includes (i) generating, via the first model, metric(s), where each of the metrics is configured to measure a respective operating state of the determined operating state(s) and (ii) analyzing, via a second model, the determined operating state(s) based on the generated metric(s). According to one such embodiment, the second model includes a machine learning model, a statistical distribution model, a polynomial decomposition model, a pattern matching model, a numerical similarity model, and/or an entropy model. In an example embodiment, analyzing the determined operating state(s) includes identifying (i) a boundary or boundaries of the determined operating state(s), (ii) duration(s) of the determined operating state(s), (iii) pattern(s) of the determined operating state(s), (iv) key sensor(s) of the determined operating state(s), (v) feature(s) of the determined operating state(s), and/or (vi) an index or indices of the determined operating state(s). According to another embodiment, the method further includes generating human-readable output(s) corresponding to the identified pattern(s) of the determined operating state(s).

An example embodiment is directed to a computer-implemented method for selecting a set of sensors of physical assets. In one such embodiment, the method receives sensor data from multiple physical assets. According to an embodiment, the sensor data is collected from multiple sensors of the physical assets over multiple time periods. Next, in an embodiment, the method receives annotations representing an operating state of each of the multiple physical assets at each of the multiple time periods. According to an example embodiment, the method then selects a set of the multiple sensors of the physical assets based on changes in operating states correlated with changes in the sensor data.

In another embodiment, the method further includes correlating the changes in operating states to the changes in the sensor data by analyzing the sensor data at the multiple time periods. According to an embodiment, correlating the changes in operating states to the changes in the sensor data by analyzing the sensor data at the multiple time periods includes using a first model. In one such embodiment, the first model includes a machine learning model, an oscillation frequency model (e.g., a model based on a frequency or wavelength [i.e., an inverse of frequency] of a sensor signal oscillation), a signal-to-noise ratio (SNR) model, a sensor physics model (e.g., a model based on a type of physics, for instance, temperature, speed, or pressure, measured by a sensor), and/or a sensor type-based model.

An example embodiment is directed to a computer-implemented method for determining criteria for acquiring data from sensors of physical assets. In one such embodiment, the method receives annotations representing a set of preselected sensors of multiple physical assets. According to an embodiment, the preselected sensors are preselected by correlating changes in sensor data collected over multiple time periods from multiple sensors of the multiple physical assets to changes in operating states of the multiple physical assets. Next, in another embodiment, the method determines criteria for acquiring data from the set of preselected sensors by identifying data output pattern(s) of the set of preselected sensors.

In an embodiment, identifying the data output pattern(s) of the set of preselected sensors includes using a first model. According to another embodiment, the first model includes a missing data index model, a peak analysis model, and/or a frequency change model. Further, in yet another embodiment, identifying the data output pattern(s) of the set of preselected sensors includes assigning output data of the set of preselected sensors to a category or categories. According to an example embodiment, the category or categories include stable state(s), transition state(s), and/or recovering state(s).

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flow diagram illustrating an example embodiment of an asset lifecycle.

FIG. 2A is a picture illustrating an example embodiment of a centrifugal pump.

FIG. 2B is a block diagram illustrating an example embodiment of a system for a centrifugal pump.

FIG. 2C is a graph illustrating an example embodiment of optimized performance for a centrifugal pump.

FIGS. 3A-C are graphs illustrating example embodiments of distributions of metrics for sensor selection.

FIG. 4 is a graph illustrating an example embodiment of a sensor missing data index.

FIG. 5 is an image of graphs illustrating an example embodiment of locations of missing sensor data.

FIG. 6 is a two-dimensional (2D) plot illustrating an example embodiment of asset operating states by a linear method.

FIG. 7 is a 2D plot illustrating an example embodiment of asset operating states by a nonlinear method.

FIG. 8 is a 2D graph illustrating an example embodiment of metrics to measure deviation from an optimized asset operating state.

FIG. 9 is a graph illustrating an example embodiment of asset operating state change trends.

FIG. 10 is a graph illustrating an example embodiment of dynamic correlation measured with von Neumann entropy.

FIG. 11 is a plot illustrating an example embodiment of calculating sensor distance ranks with Mahalanobis distance.

FIG. 12 is a flow diagram illustrating an example embodiment of a method embodying the present disclosure.

FIG. 13 is a flow diagram illustrating an example embodiment of another method embodying the present disclosure.

FIG. 14 is a flow diagram illustrating an example embodiment of yet another method embodying the present disclosure.

FIG. 15 is a flow diagram illustrating an example embodiment of a data mining service.

FIG. 16 is a schematic view of a computer network in which embodiments may be implemented.

FIG. 17 is a block diagram illustrating an example embodiment of a computer node in the computer network of FIG. 16.

### DETAILED DESCRIPTION

A description of example embodiments follows.

There are numerous types of physical assets used across different industries. One non-limiting example of a physical asset is a compressor. Other non-limiting examples of assets used in the transportation industry, include locomotive and train engines. Further non-limiting examples of assets in the mining industry including various assets such as, e.g., loaders. A person of ordinary skill in the art can understand that other assets can be employed in conjunction with the present disclosure, and the above examples are non-limiting.

Certain embodiments of the present disclosure address various problems arising in physical asset lifecycle management and APM. For example, there may be a need to identify or predict when an asset will fail, such as, when the asset's operating state corresponds to a failure mode. According to one such embodiment, identifying or predicting such a failure mode may provide an early indicator of a problem with the asset. Further, in another embodiment, there may be a need to determine an optimized operating state or mode for a given physical asset. According to an embodiment, determining such an optimized operating state or mode may help achieve, e.g., maximum output, for the asset. Lastly, in yet another embodiment, there may be a need to characterize or recognize different asset operating states. According to an embodiment, asset operating states may be characterized as, e.g., “optimized,” “normal,” or “problematic.” In one such embodiment, charactering or recognizing different operating states may facilitate providing appropriate guidance to asset operators, such as a recommendation to take no action when an asset is already in an optimized state.

Conventional approaches to physical asset management may be helpfully illustrated by an example of personal car ownership by metaphor. After someone purchases a new car and becomes its owner, the owner assumes the car is operating properly during the first several years of ownership. The owner otherwise performs routine maintenance on the car, such as changing tires, oil changes, inspections, etc. From the owner's perspective, the only indication that the car has failed is when the car malfunctions. Despite the car having numerous sensors that can be used to obtain vast amounts of data about the car's operation, nearly all the potentially available data is disregarded or ignored during the bulk of the time the car is owned; at most, a small fraction of the data is retrieved or consulted on occasions when the car happens to be taken to a dealership or repair shop. It can thus be seen that existing approaches to physical asset maintenance are not data-driven and fail to employ techniques based on models and/or methods. Instead, conventional approaches rely, for example, on a rigid and fixed maintenance and/or inspection schedule that is not tailored to a given asset. Such existing approaches may be referred to as “corrective maintenance.” In contrast, embodiments of the present disclosure offer data-driven and/or ML-based solutions and methodologies according to a “predictive maintenance” paradigm.

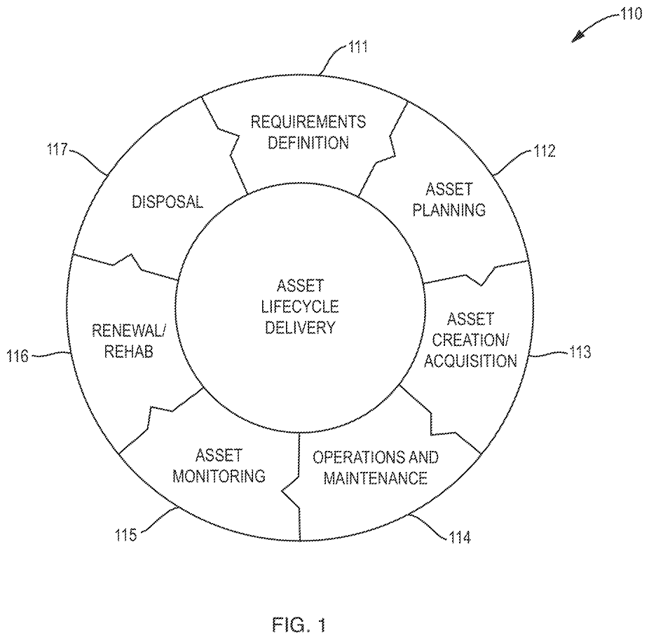

FIG. 1 is a flow diagram illustrating an example embodiment of an asset lifecycle 110. As shown in FIG. 1, lifecycle 110 begins at 111 with defining requirements, followed by asset planning at 112. Next, asset creation/acquisition takes place at 113. Lifecycle 110 then includes asset operations and maintenance at 114, and asset monitoring at 115. At 116, asset renewal/rehab may also occur. Finally, asset disposal takes place at 117. After disposal, 117, lifecycle 110 can begin again by defining or redefining requirements 111.

To maintain optimized performance of assets, embodiments of the disclosed method and corresponding system analyze an asset's types of operation, characteristics of each type of operation, and risks (including economic and safety) of operations.

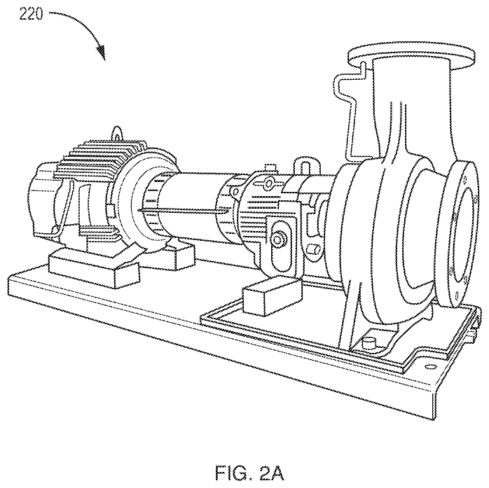

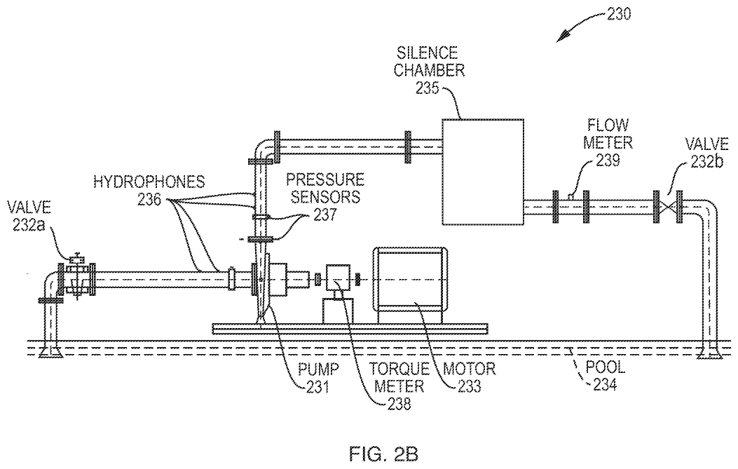

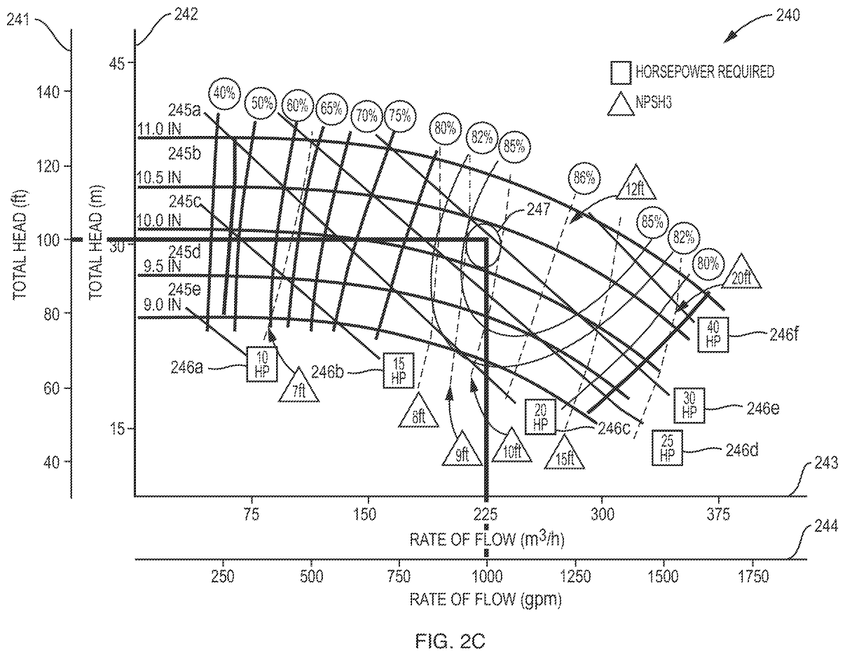

FIG. 2A is a picture illustrating an example embodiment of a centrifugal pump 220. FIG. 2B is a block diagram illustrating an example embodiment of a system 230 for a centrifugal pump. In an embodiment, system 230 may include a centrifugal pump, e.g., centrifugal pump 231 or 220 (FIG. 2A), as well as valves 232a-b, motor 233, pool 234, silence chamber 235, hydrophone(s) 236, pressure sensor(s) 237, torque meter 238, and flow meter 239. According to one such embodiment, sensors, e.g., hydrophone(s) 236, pressure sensor(s) 237, torque meter 238, and flow meter 239, may form a measurement or data acquisition subsystem of overall system 230, which subsystem may be used for obtaining various data regarding operations of, e.g., centrifugal pump 231 or 220.

FIG. 2C is a graph 240 illustrating an example embodiment of optimized performance for a centrifugal pump, e.g., pump 220 (FIG. 2A) or 231 (FIG. 2B). As shown in graph 240, in an embodiment, Y (vertical) axes 241 and 242 are total pump head in feet and meters, respectively. X (horizontal) axes 243 and 244 are pump flow rate (capacity) in m³/h (cubic meters/hour) and gpm (gallons per minute), respectively. Downward sloping lines 245a-e are pump head capacity curves. Numbers above head capacity curves 245a-e to a right of the Y axes represent different impeller diameters; total head is reduced when impeller diameter is reduced. Numbers in circles above topmost head capacity curve 245a are pump efficiency; lines stemming from each circled number are lines of constant efficiency. Triangles containing a number of feet (ft) are constant lines of NPSH (net positive suction head) that a system must supply for a pump to operate with a 3% head loss (NPSH3); a NPSH margin above a corresponding value is required for a pump to operate at a published head. Diagonal lines 246a-f running through head capacity curves 245a-e signify lines of constant pump input power; input powers 10 HP (horsepower), 15 HP, 20 HP, 25 HP, 30 HP, and 40 HP correspond to respective lines of constant pump input power 246a-f.

As shown in graph 240 of FIG. 2C, according to an embodiment, an optimized asset operating state may be located in a region 247 defined by nonlinear functions over multivariate parameters. For example, in an embodiment, region 247 may correspond to a flow rate of 1,000 gpm and a total head of 100 feet.

Embodiments of the present disclosure offer a new system and method to address several problems in the optimization of physical asset life operation by using ML methodologies. As shown in FIG. 2C, a pattern of an optimized operating state of a centrifugal pump, e.g., pump 220 (FIG. 2A) or 231 (FIG. 2B), includes multiple parameters. In other solutions, experienced engineers need to combine all parameters to make a decision to confirm if these parameters imply an optimized state or problematic state. In contrast to these previous manual labor-intensive solutions, embodiments of the present disclosure use ML methodologies to model an optimized asset operating state, thereby improving automation. In addition, ML models are often regarded as a “black box” and are often difficult to relate directly to knowledge familiar to field engineers. With existing approaches, models of an optimized asset operating state, e.g., corresponding to region 247 of FIG. 2C, may not immediately imply characteristics of physical metrics such as power, flow, etc., in a straightforward way—e.g., by providing an analysis of each physical metric separately. Some embodiments of the present disclosure improve comprehension of ML results by providing a single index to measure a deviation of asset operation from its optimized state. In an example embodiment, for predicted sub-optimized asset operations or asset failures, it is extremely valuable to identify a root cause so that field engineers can make corresponding maintenance and repair to keep an asset operating in an optimized state. Certain embodiments of the present disclosure provide a scaled feature distance method to report leading parameters that contribute to an underlying problem.

From years of research, development, and practice by Aspen Technology, Inc. (Bedford, MA), several critical asset maintenance problems have been solved through U.S. Pat. No. 9,535,808, titled “Systems And Methods For Automated Plant Asset Failure Detection,” and U.S. Pat. No. 11,348,018, titled “Computer System And Method For Building And Deploying Models Predicting Plant Asset Failure,” both of which are herein incorporated by reference in their entirety, and through products such as Aspen Mtell® and Aspen ProMV®.

In summary, embodiments of the present disclosure address strategic problems including, but not limited to:
a) Maintaining and improving performance of asset operations to reach a best output with respect to both economy and safety,
b) Identifying a root cause if asset operation deviates from an optimized state, and
c) Improving asset automation from problem prediction to a maintenance plan.

Certain embodiments include a data processing pipeline to perform functions including:

a) Selecting critical sensors and sensor data that are relevant to asset operation,
b) Designing hybrid methods to identify asset operation types,
c) Extracting fingerprints of asset operations,
d) Providing risk and performance assessment and prediction of asset operations,
e) Developing a workflow to provide customer-facing metrics, and
f) Deploying a service or microservice to execute functions for on-premises, cloud, and edge devices.

Embodiments of the present disclosure provide advantages over existing practices and research, with advantages including, but not limited to:
a) Selection of sensors and sensor data in condition-based monitoring is highly dependent on field operators' experience and knowledge according to a manual procedure. Some embodiments of the present disclosure adopt hybrid approaches to improve automation and accuracy of sensor and sensor data selection. Other exemplary techniques incorporated in certain embodiments of the present disclosure include, but are not limited to:
   i. peak analysis—apply topographic prominence to monitor scale of changes
   ii. trend analysis—apply Wold and STL (Seasonal-Trend decomposition using locally estimated scatterplot smoothing (LOESS)) decompositions to handle data with different frequencies and statistical distributions
   iii. envelope—apply Hilbert-Huang transform (HHT) to determine an upper and lower boundary of data
   iv. statistic change—apply Bayesian change point to monitor local statistical changes
b) Characteristics of asset operations used to be defined by domain experts based on their experiences in a spreadsheet fashion. Some embodiments provide fingerprints of important asset operations in a format of latent features through combining domain expertise and data mining. Additional functionality of certain embodiments includes, but is not limited to:
   i. Visualization—applying an ensemble of PCA, RBM, t-SNE, and UMAP to provide improved visual perception on operating states
   ii. Distance metrics—ensemble of statistical distribution, Euclidean, Mahalanobis, and local connected closeness to provide different clusters to represent asset operating states
   iii. Finetune—apply expert-based templates to adjust operating states
c) A root cause of asset operation risks may be difficult to identify and validate. Before the present solution, too often a lot of eyeballing is involved in decision making. In the present disclosure, certain embodiments provide a supervised ML approach to standardize an analysis and validation process by using feature importance analysis and template matching.
d) Existing deployment approaches of asset operation monitoring are based on desktop applications, whereas some embodiments offer a unified mechanism to deploy functions for on-premises, cloud, and edge devices.

In some embodiments of the present disclosure, a system data processing workflow includes steps of sensor selection, sensor data selection, sensor data clustering, and pattern analysis of clustered sensor data. More details about each step are elaborated hereinbelow with many examples.

### Sensor Selection

According to an example embodiment, data selection for asset operating state analysis includes two parts: (1) initial selection of sensors and (2) selection of data for a given group of selected sensors.

In some embodiments, sensor selection identifies relevant sensors used to define operating states of an asset. While a physical asset may have a certain number of sensors, e.g., 100 sensors, only a subset of those sensors (e.g., 20-50 sensors, in one example) may be relevant to analyzing operating states of the asset. Further, in some embodiments, reducing the number of sensors under consideration when determining an asset operating state may increase the speed of the process and/or make it more computationally efficient.

According to an example embodiment, sensor selection may be performed using hybrid approaches—e.g., approaches combining domain knowledge and ML methods—that vary depending on a particular industry.

In some embodiments, inputs to a method for sensor selection may include, for example: (i) raw data from a list of sensors in a form of multivariate time series, (ii) asset meta information such as temperature, pressure, flow, volume, etc., and/or (iii) records of historical asset performance. According to one such embodiment, a method for sensor selection may produce as output a list of selected sensors that are important to asset behavior. In an embodiment, one or more suitable methods known to those of skill in the art may be used for sensor selection. According to an embodiment, such methods may include, but are not limited to: (i) regrouping sensors by data oscillation frequency/wavelength, (ii) regrouping sensors by sensor data statistics from moving windows, and/or (iii) grouping together similar sensors based on physics such as temperature, pressure, flow, and volume, etc. In an embodiment, a sensor grouping technique may include unsupervised learning, which does not rely on existing domain knowledge. For example, according to one such embodiment, a sensor grouping technique may involve creating multiple different groups of sensors, followed by identifying particular sensors or groups of sensors that contribute to determining asset operating states. In another embodiment, a physical asset may have 400-500 sensors; thus, manual identification of relevant sensors by human operators is highly infeasible. A person of ordinary skill in the art can recognize that other numbers of sensors can be employed, and the above numbers are non-limiting, but exemplify a scope of the processing required.

Similarly, in an embodiment, any suitable metrics known to those of skill in the art may be used in performing sensor selection or grouping. For example, according to an embodiment, metrics such as sensor data signal oscillation wavelength/frequency, sensor data SNR level, and sensor physics/types may be used to select sensors for asset operating state analysis. In an embodiment, other known metrics may include, but are not limited to, dynamic correlation and trend in moving intervals.

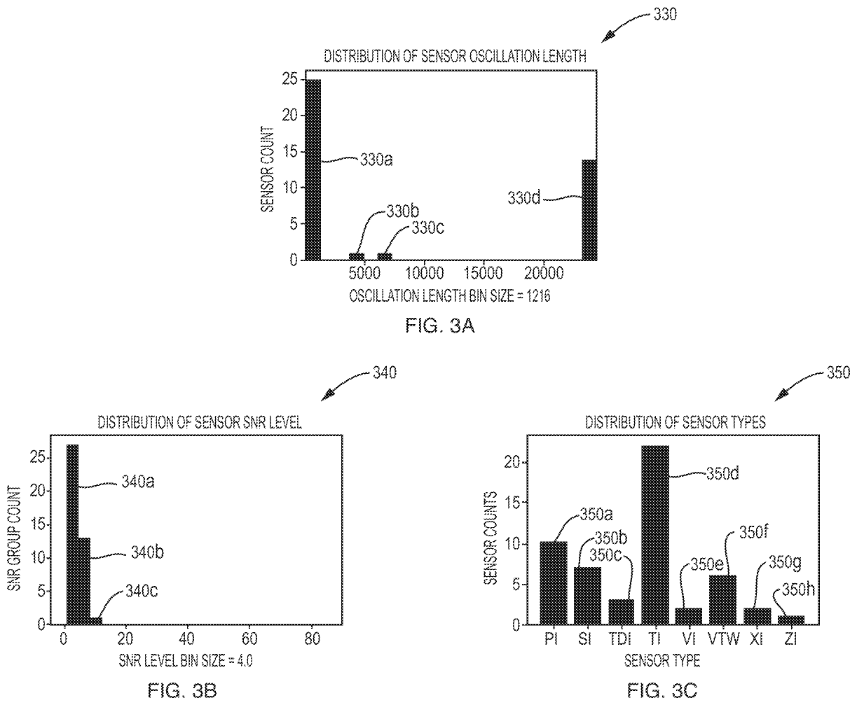

FIGS. 3A-C are graphs 330, 340, and 350, respectively, illustrating example embodiments of distributions of metrics for sensor selection.

Graph 330 of FIG. 3A illustrates an example embodiment of a distribution of sensor data signal oscillation wavelength (length). As shown by FIG. 3A, graph 330 includes histogram bars 330a-d. In an embodiment, as indicated by graph 330, a bin or interval (or bucket) size of 1,216 may be used. Thus, for example, a first bin may include data points with a wavelength of 0 to 1,215, a second bin may cover wavelengths from 1,216 to 2,431, a third bin may cover wavelengths from 2,432 to 3,647, and so on. Each bin may be plotted as a bar, e.g., bar 330a, 330b, 330c, or 330d, with a height corresponding to how many data points are in that bin.

In some embodiments, oscillation sensors that sense, e.g., rotating components of an asset, may have different revolutions per minute (RPM). Using multiple, identically-sized bins, such as in graph 330, may allow sensors with different RPM to be grouped according to similar wavelengths. In other embodiments, an oscillation wavelength cutoff or threshold may be used for selecting or grouping sensors.

Continuing with FIG. 3A, in an embodiment, histogram bar 330a may include data points for sensors with similar types/physics, e.g., sensors that measure different types of pressure flow data.

Graph 340 of FIG. 3B illustrates an example embodiment of a distribution of sensor SNR levels. As shown by FIG. 3A, graph 331 includes histogram bars 340a-c. In an embodiment, as indicated by graph 340, an SNR level bin size of 4.0 may be used. According to some embodiments, SNR may be defined as, e.g., a ratio of a sensor signal mean to a standard deviation of noise. The value for noise may be an estimate thereof. Alternately, noise may be assumed to follow a Gaussian or other known distribution.

In an example embodiment, a sensor with a comparatively low SNR level may be selected for use in asset operating state analysis. Moreover, graph 331 with histogram bars 340a-c may be used to select or group sensors having similar ranges of SNR values. For example, a temperature sensor and a pressure sensor may have different meanings for their outputs, but grouping them by SNR levels allows them to be standardized/normalized according to a “neutral” criterion for ease of comparison. As a further example, a neutral criterion such as SNR levels may permit selection or grouping of sensors having data signals with oscillation and sensors having data signals with infrequent oscillation, where otherwise sensors in the former group would dominate over or drown out those in the latter group.

Graph 350 of FIG. 3C illustrates an example embodiment of a distribution of sensor physics/types. As shown by FIG. 3A, graph 331 includes histogram bars 350a-h. In an embodiment, each of histogram bar 350a-h may correspond to a particular sensor type or sensor category that measures a particular physical aspect of a component. Thus, for example, bar 350a may be labeled “PI” for P(ressure) I(ndicators)/sensors; bar 350b may be labeled “SI” for S(peed) or S(urge) I(ndicators)/sensors; bar 350c may be labeled “TDI” for T(emperature) D(ifference) I(ndicators)/sensors; bar 350d may be labeled “TI” for T(emperature) I(ndicators)/sensors; bar 350e may be labeled “VI” for V(olume) I(ndicators)/sensors; bar 350f may be labeled “VTW” for V(ersa)T(ek)™ W(ireless), e.g., pressure measurement, sensors; bar 350g may be labeled “XI” for (Flu)X I(ndicators)/sensors; and bar 350h may be labeled “ZI” for compression ratio sensors. In an example embodiment, sensor type/physics labels may vary according to industry, vendor, and/or technical domain; further, any suitable sensor type/physics labels known to those of skill in the art may be used. According to one such embodiment, sensors of the same type but having different labels may nonetheless be grouped and/or categorized by applying known text clustering techniques to the sensors' labels. Alternately, instead of using labels corresponding to sensor type/physics, sensors may be selected or grouped based on similarity in data outputs.

In an embodiment, the above criteria of sensor oscillation wavelength/frequency, sensor SNR level, and sensor physics/types may be used to combine domain knowledge and ML methods to improve a sensor selection process.

### Sensor Data Selection

In an embodiment, sensor data selection may serve to identify relevant data from raw output acquired from selected sensor(s), which data may then define operating states of an asset. As discussed hereinabove with respect to sensor selection, according to an embodiment, only a subset of available sensors for a given physical asset may be selected as relevant to analyzing operating states of the asset. Likewise, in an embodiment, only a subset of the available timeseries data from the selected sensors may be relevant to analyzing the asset's operating states.

According to another embodiment, hybrid approaches for sensor data selection that combine domain knowledge and ML methods may vary depending on a particular industry.

Further, in yet another embodiment, inputs to a method for sensor data selection may include, for example: (i) raw data from a list of sensors in a form of multivariate time series, (ii) asset meta information such as temperature, pressure, flow, volume, etc., and/or (iii) records of historical asset performance. According to an embodiment, a method for sensor data selection may output a list of time intervals in which data from selected sensors are useful.

In an embodiment, multiple different criteria may be used to select data from a given group of selected sensors. For example, according to an embodiment, such criteria may include, but are not limited to, missing data index, peak analysis, and frequency change. In an embodiment, knowledge-based criteria such as stable state, transition state, and recovering state may be used to group data into different categories. However, it should be noted that any suitable criteria known to those of skill in the art may be used.

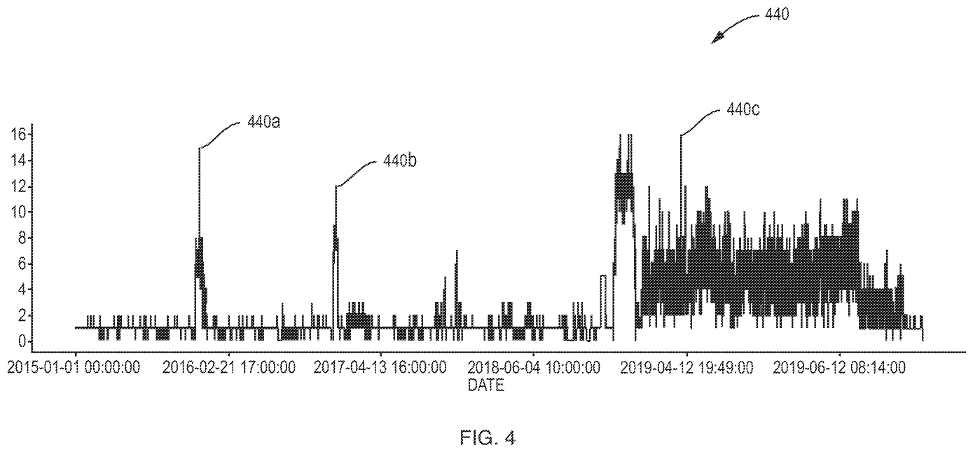

FIG. 4 is a graph 440 illustrating an example embodiment of a sensor missing data index. As shown in FIG. 4, graph 440 includes exemplary peaks 440a-c. In an embodiment, an x axis of graph 440 may correspond to a date or time dimension, while a y axis of graph 440 may correspond to a unitless dimension for a quantity of sensors (also referred to as “tags”) at a given point on the x axis. A sensor missing data index, such as illustrated by graph 440, may be used to measure a quantity or number of sensors that are missing data (e.g., sensors with “flat” or “frozen” outputs) at a particular time or date. Thus, for example, at a date/time corresponding to peak 440a, more than 14 sensors may have missing data; at a date/time corresponding to peak 440b, 12 or more sensors may have missing data; and at a date/time corresponding to peak 440c, as many as 16 sensors may have missing data.

In an embodiment, various techniques, such as ML methods, among other examples, may be used to automatically determine a severity of missing sensor data.

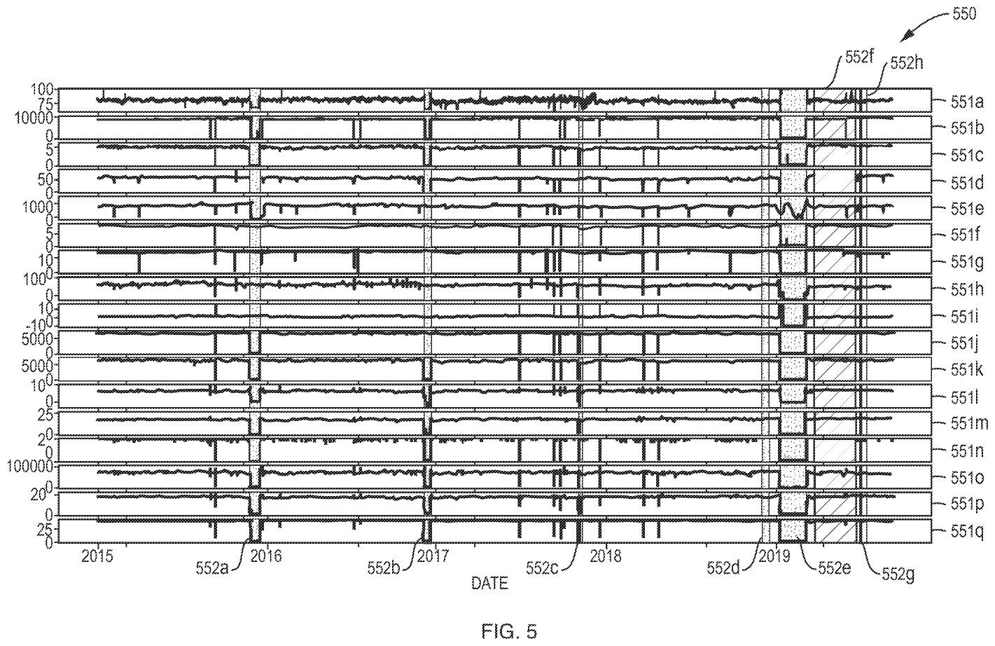

FIG. 5 is an image 550 of graphs 551a-q illustrating an example embodiment of locations of missing sensor data. As shown in FIG. 5, each of graphs 551a-q displays an exemplary data output for a single sensor plotted over time. Image 550 also includes highlighted regions 552a-g. According to an embodiment, regions 552a-g may indicate timestamps or ranges of timestamps where one or more sensor data outputs as displayed by graphs 551a-q are missing or “flat.” In some embodiments, a width and/or shading of each region 552a-g may indicate a severity or intensity of missing data across one or more sensor outputs plotted in graphs 551a-q.

According to an embodiment, various techniques, such as ML methods, among other examples, may be used to automatically find a location of missing sensor data, as well as measure a sparsity or density or missing sensor data at a particular timestamp or range of timestamps.

### Sensor Data Clustering

In an embodiment, asset operating states may be identified or predicted by clustering data obtained from sensors according to a different criterion or criteria. According to one such embodiment, sensor data may be multivariate time series data, and clustering may be performed according to domain-specific criteria. In an example embodiment, determining sensor data clusters may be valuable to physical asset operators, because asset operators, who are human, lack the practical ability to digest or comprehend voluminous amounts of raw sensor data. Thus, according to an embodiment, further analysis, including, e.g., clustering, may be necessary to make sensor data understandable for human end-users.

Some embodiments may also create, e.g., domain-dependent and/or ML distances to measure clusters of sensor data. According to another embodiment, each cluster of sensor data for a particular timeseries or timestamp corresponds to an operating state of a physical asset.

Further, in yet another embodiment, inputs to a method for sensor data clustering may include, for example: (i) preprocessed multivariate timeseries sensor data (which may be provided as, e.g., a spreadsheet) and/or (ii) initial sensor data status extracted from meta data. According to an embodiment, a method for sensor data clustering may produce as output, for example: (i) a label to indicate an asset operating state for each timestamp, (ii) a 2D map of all recognized asset operating states, and/or (iii) metrics to measure significances of recognized asset operating states. In one such embodiment, one or more suitable methods known to those of skill in the art may be used for sensor data clustering. According to an embodiment, methods used for sensor data clustering may include, but are not limited to: (i) dimensionality reduction methods such as PCA, RBM, t-SNE, UMAP, and/or their ensemble, (ii) data clustering methods such as SOM, density-based models, e.g., HDBSCAN (hierarchical density-based spatial clustering of applications with noise), mixture models, e.g., a GMM (Gaussian mixture model), LOF, and/or their ensemble, and/or (iii) expert-based templates to fine tune asset operating states recognized by methods.

In an embodiment, any model/method-based techniques or combination/ensemble thereof may include an unsupervised learning approach; according to one such embodiment, as discussed herein, unsupervised learning does not rely on training data previously labeled or tagged by human experts. In another embodiment, a provisional or initial analysis may be performed on an existing data collection. For example, according to an embodiment, the data collection may include asset operating data over, e.g., a two-year timespan, which may reflect hourly acquisitions of asset sensor data during that timespan. In an embodiment, the initial analysis may identify, e.g., three or four, operating states into which the data may be clustered.

According to an example embodiment, expert domain knowledge may also be consulted to adjust or refine asset operating states identified via model/method-based techniques, such as ML approaches, including, e.g., unsupervised learning. In one such embodiment, asset operating state templates or signatures that have been refined using expert domain knowledge may then be fed back into a model or method, for example, in the form of training data used by the model or method.

In another embodiment, templates may include prior historical data, such as asset operating states previously identified or recognized by a model and/or method. According to one such embodiment, templates or previously recognized operating states may further be labeled or tagged by human experts who possess relevant domain knowledge. In an example embodiment, existing templates—either labeled or unlabeled—may in turn be used for additional training of a model and/or method. While asset operating state labels such as “optimized,” “normal,” and “problematic” have been described herein, according to an embodiment, other possible tags or labels may include, but are not limited to, “good,” “bad,” “transition,” etc.; in one such embodiment, labelling an operating state as transitional may indicate that a physical asset is transitioning between different operating states.

Further, in yet another embodiment, sensor data clustering may be performed using one or more of a variety of known distance metrics, such as Euclidean, Mahalanobis, angles, etc., among other examples. According to an embodiment, clustering techniques may also include mixing statistical and grid distances. In some embodiments, a sensor data clustering technique may employ a process to find an optimized number of clusters. According to an example embodiment, ensemble measurement may be used to determine closeness of clusters.

In an embodiment, guidance and/or recommendations may be provided that correspond to an identified asset operating state. For example, according to one such embodiment, the provided guidance and/or recommendations may include solutions for optimizing a physical asset's operation, or for avoiding failure of a physical asset.

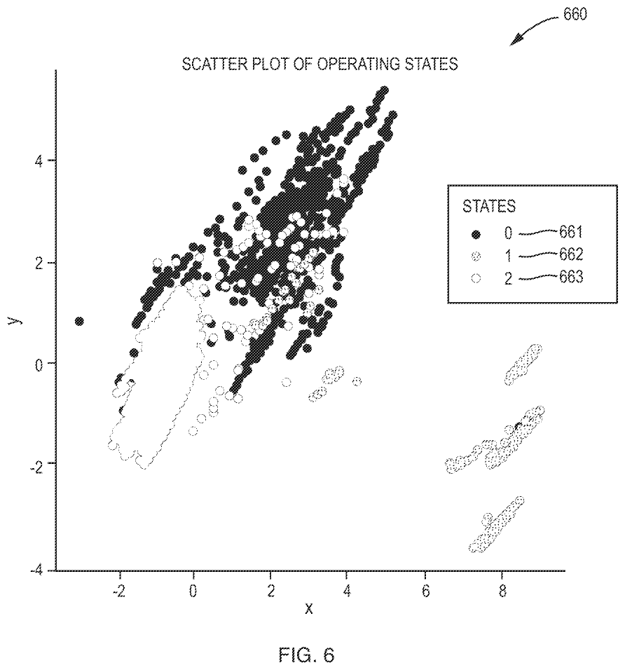

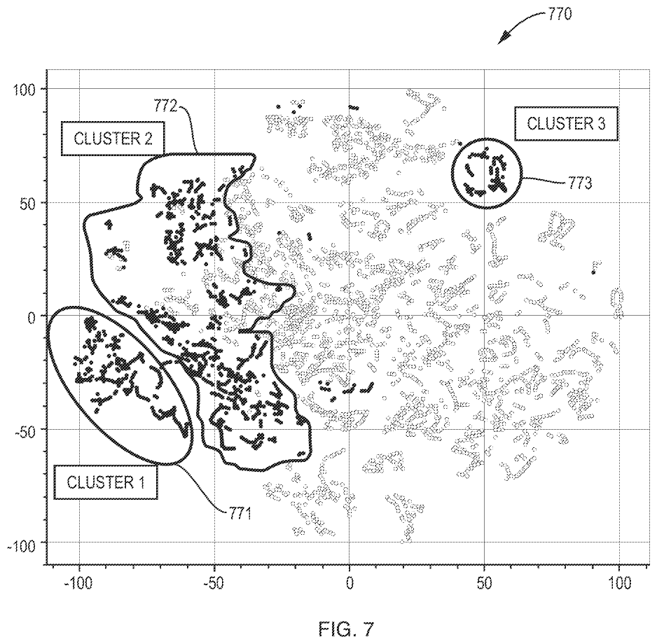

In another embodiment, many different methods exist to extract asset operating states by using domain knowledge and data-driven ML approaches. According to certain embodiments, FIGS. 6 and 7 provide two examples to show how asset operating states look in a human-digestible manner.

FIG. 6 is a two-dimensional (2D) plot 660 illustrating an example embodiment of asset operating states by a linear method. As shown in FIG. 6, in an embodiment, each operating state 661, 662, and 663 is indicated by different color/shading.

FIG. 7 is a 2D plot 770 illustrating an example embodiment of asset operating states by a nonlinear method. As shown in FIG. 7, in an embodiment, locations of operating states 771, 772, and 773 are identified by nonlinear clusters.

Due to the nature of asset physics, according to an embodiment, multiple criteria may be necessary to describe asset operating states in different industries. In an embodiment, a variety of methods, including, but not limited to HDBSCAN, GMM, LOF, and others, may be used to cover industries such as oil and gas, refining, mining, paper and pulp, etc. However, it should be noted that any suitable criteria and/or methods known in the art may be used.

### Cluster Pattern Analysis

In an embodiment, cluster pattern analysis may be performed to achieve: (i) identifying key sensors of each cluster, (ii) extracting features of clusters, (iii) identifying trends of clusters, (iv) determining a performance index of clusters, and/or (v) determining a risk index of clusters.

Further, in another embodiment, inputs to a method for cluster pattern analysis may include, for example: (i) a list of recognized asset operating states in a form of multiple intervals of multivariate time series and (ii) one or more distance types used to recognize asset operating states. According to an embodiment, a method for cluster pattern analysis may produce as output, for example, one or more of: (i) a boundary and duration of each asset operating state, (ii) statistics of all training data for each asset operating state, (iii) a trend template for each asset operating state, and/or (iv) an entropy-based index to measure associations among time series. In one such embodiment, one or more suitable methods known to those of skill in the art may be used for cluster pattern analysis. According to an embodiment, methods used for cluster pattern analysis may include, but are not limited to: (i) applying SVMs (support vector machines), statistical distributions, and/or neural network activation to define a boundary of each asset operating state, (ii) applying orthogonal polynomial decomposition to extract a local trend of each asset operating state, (iii) mixing trend pattern matching—including, for example, trend pattern analysis using moving windows—and numerical similarity measures, and/or (iv) von Neumann entropy or other known entropy measures.

### Measuring Deviation From Optimized Asset Operating States

In an embodiment, several metrics have been explored to measure deviation from an optimized or ideal asset operating state.

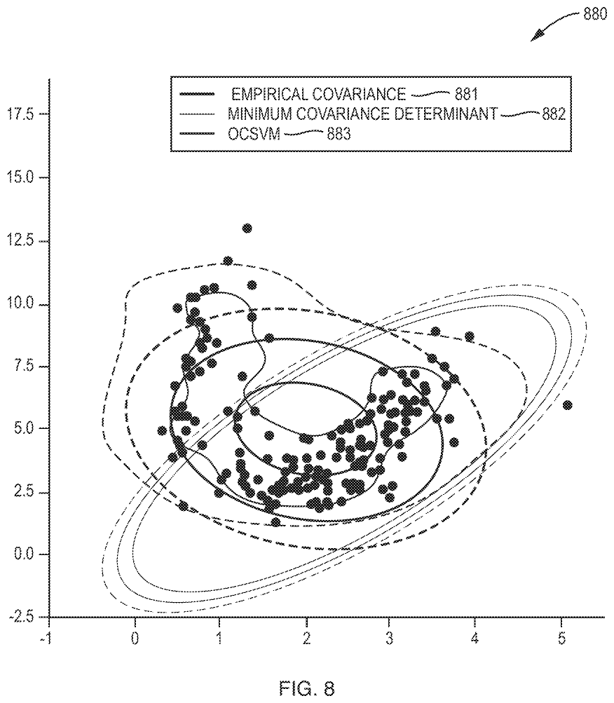

FIG. 8 is a 2D graph 880 illustrating an example embodiment of metrics 881-883 to measure deviation from an optimized asset operating state. As shown in FIG. 8, each metric 881, 882, and 883 may be indicated by a different color and/or shading. In an embodiment, metrics to measure deviation from an optimized asset operating state may include any suitable metrics known in the art, such as empirical covariance 881, robust covariance/minimum covariance determinant (MCD) 882, and OCSVM (one-class SVM) 883, among other examples. Different metrics may serve different purposes. For example, a metric such as 881 or 882 that yields an oval or ellipse shaped coverage region may be sufficient to determine a rough or “macro” grouping of data points. In contrast, a metric such as 883 may be used when a more precise/accurate or “micro” grouping of data points is desired. Moreover, it should be noted that in some embodiments, metrics, such as metrics 881-883, may not correspond to a boundary with a predefined shape, but may instead calculate a boundary shape based on one or more aspects of the data points to be analyzed. According to an example embodiment, a solid line for a particular metric 881, 882, or 883 in FIG. 8 may indicate a higher confidence value, while a dashed line may indicate a lower value. It should be further noted that, although 2D graph 880 is shown in FIG. 8 for illustration purposes, in other embodiments, analyzing output signals from multiple sensors for an asset, such as an industrial asset, may include performing calculations on very high-dimensional data.

In other embodiments, measuring distances between an optimized or ideal asset operating state and other operating states that have deviated or drifted from the optimum may involve using a combination of one or more ML techniques and/or domain knowledge to establish a practical approach. Certain embodiments offer a hybrid approach of combining all information to build a stable and robust means for product development.

### Asset Operating State Fingerprints

To characterize physical asset operating state patterns in a human-digestible way, some embodiments provide a fingerprint approach to convert a sensor output pattern into a text trend as a template of each operating state.

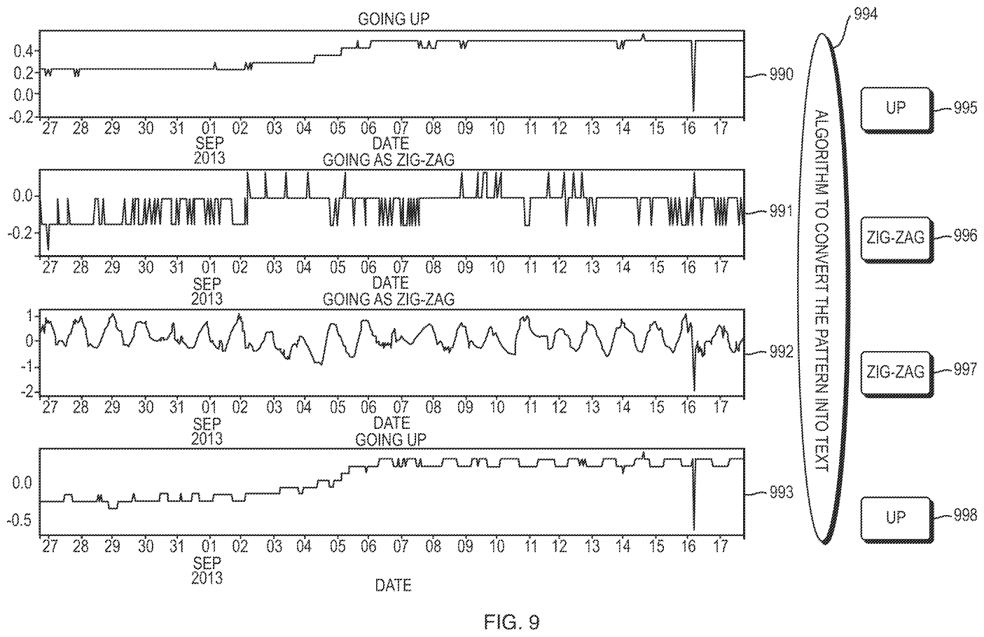

FIG. 9 is a graph illustrating an example embodiment of asset operating state change trends. In an embodiment, as shown in FIG. 9, patterns 990, 991, 992, and 993 in windowed intervals are used by method 994 to generate corresponding text trends 995, 996, 997, and 998, the latter of which may include human-readable identifiers or labels such as “up” and “zig-zag,” among other examples. Thus, according to one such embodiment, complex and potentially high-dimensional numeric data, which cannot be readily understood by a human user, may instead be substituted with simple, easy to comprehend textual information.

In another embodiment, any mismatch of a trend immediately indicates an origin of potential problems in a qualitative way. According to an embodiment, example change trends shown in FIG. 9 may offer a way to identify which sensor(s) is/are inconsistent with corresponding data output pattern(s) in an optimized mode. Moreover, by providing more details on a local trend of each sensor, such as exemplary human-readable text labels shown in FIG. 9, certain embodiments may provide field engineers with explainable information regarding changes of asset components.

### Asset Operating State Entropy

Some embodiments also provide quantitative measurement of asset operating state deviation from an optimized state. Certain other embodiments may employ ML approaches to quantitatively measure such deviation. In an embodiment, an index may be derived and/or an entropy trend may be identified by applying an entropy metric, such as von Neumann entropy, in a local moving window to measure dynamic correlations among sensor data. According to one such embodiment, the resulting index may be a unified or consolidated index to indicate a health status of sensor(s) of a physical asset. It should be noted that, although von Neumann entropy is discussed herein, any suitable entropy metric known to those in the art may be used.

In another embodiment, a value of asset operating state entropy may provide insight as to whether the asset sensors are operating in a “messy” (unsynchronized) or “harmonized” (synchronized) mode. Thus, according to an example embodiment, a low entropy value may correspond to the sensors being synchronized, but if entropy is high, this may mean that the sensors are unsynchronized.

According to yet another embodiment, the von Neumann entropy of a quantum state p may be defined as follows:

$$S ( ρ ) = - {\sum }_{x} {λ}_{x} log {λ}_{x}$$

In an embodiment, logarithms in the above formula may be taken to base two. According to an example embodiment, if λₓ are eigenvalues of p, then the above formula may be re-expressed as follows:

$$S ( ρ ) ≡ - tr ( ρlogρ )$$

In yet another embodiment, S(p) may be zero if and only if p represents a pure state; S(p) may be maximal and equal to In N for a maximally mixed state, N being a dimension of a Hilbert space; and S(p) may be invariant under changes in a basis of p, that is, S(ρ)=S(UρU^{†}), with U being a unitary transition.

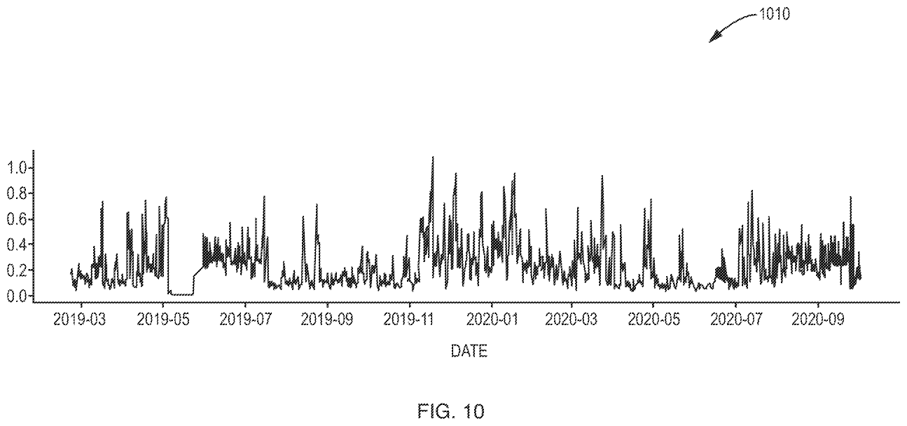

FIG. 10 is a graph 1010 illustrating an example embodiment of dynamic correlation measured with von Neumann entropy. In an embodiment, as indicated by graph 1010, an interval length of, e.g., 51 hours, may be used for each measurement window. As shown in FIG. 10, graph 1010 plots a value for entropy between 0.0 and 1.0 at each timestamp. In an embodiment, a high value for entropy—e.g., at or near 1.0—may indicate a correspondingly high information content. Thus, for example, when data readings are taken from a certain number of sensors, all of which measure either temperature or pressure, entropy measurements and accordingly information content may be low. But if data readings are taken from the same number of sensors where the variety of sensor types is greater, entropy measurements and accordingly information content may be higher than in the preceding example.

In another embodiment, known methods such as autoencoders, among other examples, may also be used to reflect asset operating state complexity and diversity.

### Root Cause Analysis

A goal of root cause analysis is to find contributing sensors that lead to an asset operating state deviation from an optimized state. Such analysis is complicated and, in certain embodiments, may require multiple approaches that use ML technologies together with domain knowledge to provide reliable results. For example, a typical asset may have hundreds or even thousands of sensors, thus making a root cause analysis beyond the practical abilities of a human operator. According to an embodiment, a variety of known methods may be used for performing root cause analysis, including, but not limited to, Mahalanobis distance, among other examples. Mahalanobis distance measures a distance between a point and a nearby state; it is unitless, scale-invariant, and accounts for correlations of a data set. In an embodiment, if a point is expressed as a set \vec{x}=(x₁, x₂, x₃, . . . , x_{N})^{T} and its nearby state is expressed as a set, \vec{μ}=(μ₁, μ₂, μ₃, . . . , μ_{N})^{T}, a full Mahalanobis distance may be calculated as follows:

$${D}_{M} ( \vec{x} ) = \sqrt{{( \vec{x} - \vec{μ} )}^{T} {S}^{- 1} ( \vec{x} - \vec{μ} )} .$$

In the above formula, S is a positive-definite covariance matrix. The result of calculating a full Mahalanobis distance may be a matrix with dimensionality based on the number of sensors. For example, if an asset has 50 sensors, calculating a full Mahalanobis distance may result in a 50×50 matrix of sensor distances.

Further, in an example embodiment, an individual Mahalanobis distance may be calculated as follows:

$${d}_{i} = d ( {x}_{i} , {μ}_{i} ) = \sqrt{{( {x}_{i} - {μ}_{i} )}^{T} {{S}_{i}}^{- 1} ( {x}_{i} - {μ}_{i} )}$$

The above equation may be used to calculate a distance for a single sensor. An individual Mahalanobis distance may represent a projection of a full Mahalanobis distance along one direction.

Lastly, according to another embodiment, a sensor distance rank may be obtained via an additive calculation as follows:

$${d}_{i} = \frac{{d}_{i}}{\sum {d}_{k}}$$

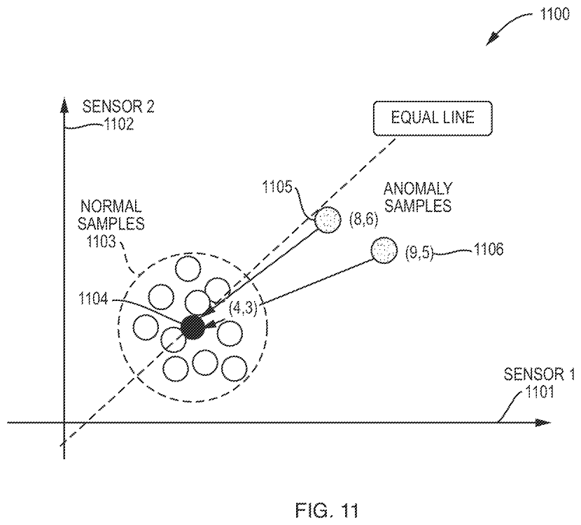

FIG. 11 is a plot 1100 illustrating an example embodiment of calculating sensor distance ranks with Mahalanobis distance. As shown in FIG. 11, in an embodiment, plot 1100 charts values for sensors 1101 and 1102, and includes points for normal samples 1103, normal center 1104, and anomalous samples 1105 and 1106. According to an example embodiment, using the above formulae, a rank for sensor 1101 with respect to anomalous samples 1105 and 1106 may be calculated as follows:

$$\frac{\sqrt{\frac{{( \text{?} - \text{?} )}^{2} + {( \text{?} - \text{?} )}^{2}}{2}}}{\sqrt{\frac{{( \text{?} - \text{?} )}^{2} + {( \text{?} - \text{?} )}^{2}}{2}} + \sqrt{\frac{{( \text{?} - \text{?} )}^{2} + {( \text{?} - \text{?} )}^{2}}{2}}} = 64 \%$$

$$\text{?} \text{indicates text missing or illegible when filed}$$

Likewise, in another embodiment, a rank for sensor 1102 with respect to anomalous samples 1105 and 1106 may be calculated as follows:

$$\frac{\sqrt{\frac{{( \text{?} - \text{?} )}^{2} + {( \text{?} - \text{?} )}^{2}}{2}}}{\sqrt{\frac{{( \text{?} - \text{?} )}^{2} + {( \text{?} - \text{?} )}^{2}}{2}} + \sqrt{\frac{{( \text{?} - \text{?} )}^{2} + {( \text{?} - \text{?} )}^{2}}{2}}} = 36 \%$$

$$\text{?} \text{indicates text missing or illegible when filed}$$

In the two example calculations above, because only two sensors are being measured, an individual Mahalanobis distance calculation for each sensor may be replaced with a simple Euclidean distance calculation instead.

According to yet another embodiment, sensor 1101 may be determined to have a greater contribution to anomalous samples 1105 and 1106 than sensor 1102 based on sensor 1101's ranking value of 64% being higher than sensor 1102's corresponding value of 36%.

In some embodiments, a sensor distance ranking may provide a benefit of identifying outlier or anomalous sensors that contribute most to a deviation from an optimized asset operating state.

Several examples are thus provided to describe a workflow from sensor selection using various metrics, recognition of operating states, extraction of operating state trends, and indices to measure sensor trend changes.

### System Deployment

Last, according to an embodiment, a unified process is proposed to deploy the functionality described herein for on-premises applications, cloud applications, and edge devices. In an example embodiment, a unified deployment process may include three parts: (1) a microservice to package the functionality; (2) computing devices to run the microservice; and (3) applications to consume the microservice. According to one such embodiment, the microservice may provide hosting for asset operating state analysis toolbox(es). In another embodiment, the microservice may run on available computing devices.

In another embodiment, the deployment process may be very important to cover diversified industries in applying the functionality described herein. Some embodiments adopt modern microservice architecture to deploy the functionality to on-premises, cloud, and edge device applications to cover both isolated installations and networked installations of workflows according to certain other embodiments. In an embodiment, a componentized binary and runtime environment may facilitate a unified deployment framework.

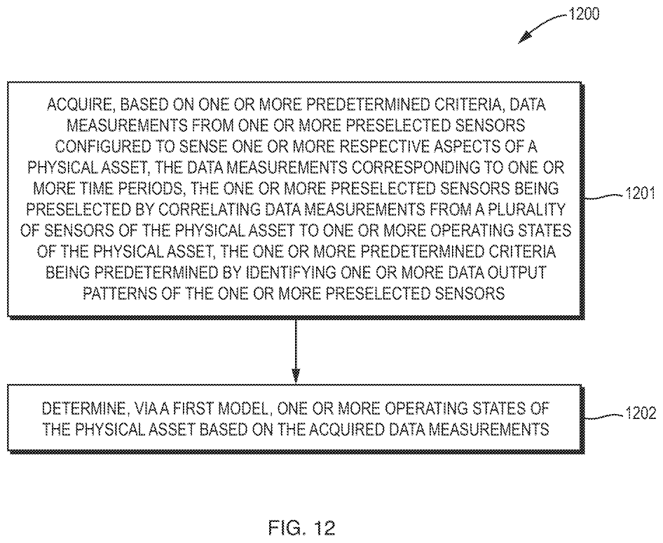

FIG. 12 is a flow diagram illustrating an example embodiment of a method 1200 embodying the present disclosure.

Method 1200 starts at step 1201. In an embodiment, method 1200 acquires, based on a predetermined criterion or criteria, data measurements from preselected sensor(s), e.g., hydrophone(s) 236, pressure sensor(s) 237, torque meter 238, and/or flow meter 239 (FIG. 2B), configured to sense respective aspect(s) of a physical asset, e.g., centrifugal pump 220 (FIG. 2A) or 231 (FIG. 2B). According to an embodiment, the data measurements correspond to time period(s), the preselected sensor(s) are preselected by correlating data measurements from multiple sensors of the physical asset to operating state(s) of the physical asset, and the predetermined criterion or criteria are predetermined by identifying data output pattern(s) of the preselected sensor(s).

At step 1202, in an embodiment, method 1200 then determines, via a first model, operating state(s), e.g., operating states 661, 662, and/or 663 (FIG. 6) and/or operating states 771, 772, and/or 773 (FIG. 7), of the physical asset based on the acquired data measurements.

In some embodiments, method 1200 further includes (i) generating, via the first model, metric(s)—e.g., metrics 881, 882, and/or 883 (FIG. 8) and/or sensor distance ranks, such as those shown in plot 1100 of FIG. 11—where each of the metrics is configured to measure a respective operating state of the determined operating state(s) and (ii) analyzing, via a second model, the determined operating state(s) based on the generated metric(s). The second model may include, for example, a machine learning model, a statistical distribution model, a polynomial decomposition model, a pattern matching model, a numerical similarity model, and/or an entropy model, e.g., a von Neumann entropy model, such as that illustrated by graph 1010 of FIG. 10.

In some embodiments of method 1200, analyzing the determined operating state(s) may include identifying, for example, (i) a boundary or boundaries of the determined operating state(s), (ii) duration(s) of the determined operating state(s), (iii) pattern(s) of the determined operating state(s), (iv) key sensor(s) of the determined operating state(s), (v) feature(s) of the determined operating state(s), and/or (vi) an index or indices of the determined operating state(s). The method 1200 may further include generating human-readable output(s), e.g., text trends 995, 996, 997, and/or 998 (FIG. 9), corresponding to the identified pattern(s) of the determined operating state(s), e.g., patterns 990, 991, 992, and/or 993 (FIG. 9).

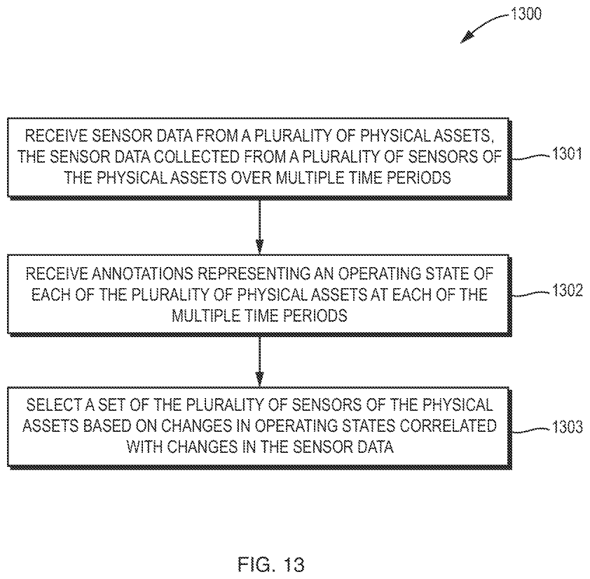

FIG. 13 is a flow diagram illustrating an example embodiment of another method 1300 embodying the present disclosure.

Method 1300 starts at step 1301. In an embodiment, method 1300 receives sensor data from multiple physical assets, e.g., centrifugal pump(s) 220 (FIG. 2A) and/or 231 (FIG. 2B). According to one such embodiment, the sensor data is collected from multiple sensors, e.g., hydrophone(s) 236, pressure sensor(s) 237, torque meter 238, and/or flow meter 239 (FIG. 2B), of the multiple physical assets over multiple time periods.

Next, at step 1302, in an embodiment, method 1300 receives annotations representing an operating state of each of the multiple physical assets at each of the multiple time periods.

At step 1303, according to an example embodiment, method 1300 then selects a set of the multiple sensors of the multiple physical assets based on changes in operating states correlated with changes in the sensor data.

In some embodiments, method 1300 further includes correlating the changes in operating states to the changes in the sensor data by analyzing the sensor data at the multiple time periods.

In some embodiments of method 1300, correlating the changes in operating states to the changes in the sensor data by analyzing the sensor data at the multiple time periods includes using a first model. The first model may include, for example, a machine learning model, an oscillation frequency model, a signal-to-noise ratio (SNR) model, a sensor physics model, and/or a sensor type-based model. An oscillation frequency model may analyze, e.g., a distribution of sensor oscillation length, such as that shown in graph 330 of FIG. 3A. Similarly, a SNR model may analyze, e.g., a distribution of sensor SNR levels, such as that shown in graph 340 of FIG. 3B. A sensor physics model and/or sensor type-based model may analyze, e.g., a distribution of sensor types, such as that shown in graph 350 of FIG. 3C.

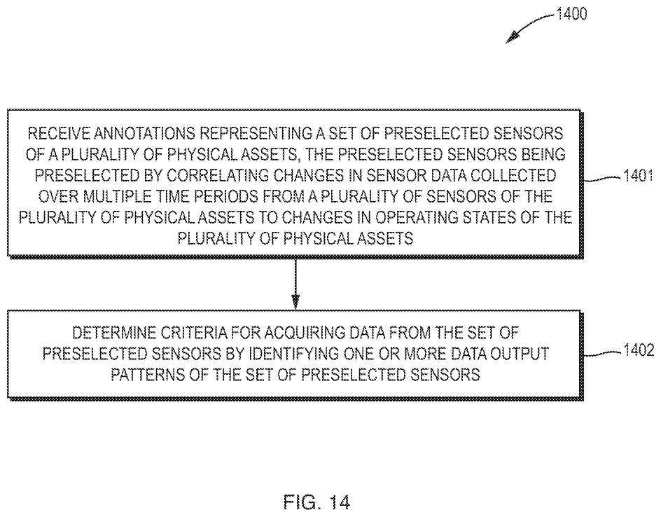

FIG. 14 is a flow diagram illustrating an example embodiment of yet another method 1400 embodying the present disclosure.

Method 1400 starts at step 1401. In an embodiment, method 1400 receives annotations representing a set of preselected sensors, e.g., hydrophone(s) 236, pressure sensor(s) 237, torque meter 238, and/or flow meter 239 (FIG. 2B), of multiple physical assets, e.g., centrifugal pump(s) 220 (FIG. 2A) and/or 231 (FIG. 2B). According to an embodiment, the preselected sensors are preselected by correlating changes in sensor data collected over multiple time periods from multiple sensors of the multiple physical assets to changes in operating states of the multiple physical assets.

At step 1402, in an embodiment, method 1400 then determines criteria for acquiring data from the set of preselected sensors by identifying data output pattern(s) of the set of preselected sensors.

In some embodiments of method 1400, identifying the data output pattern(s) of the set of preselected sensors includes using a second model. The second model may include, for example, a missing data index model, a peak analysis model, and/or a frequency change model. A missing data index model may analyze, e.g., missing sensor data indices, such as that shown in graph 440 of FIG. 4. Similarly, a peak analysis model may analyze, e.g., locations of missing sensor data, such as that shown in graph 550 of FIG. 5.

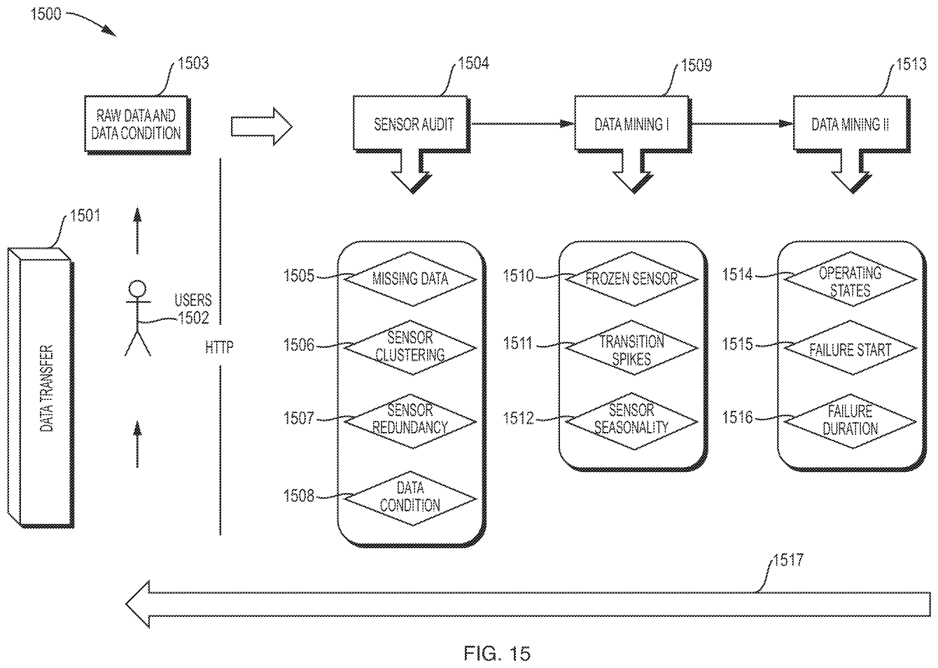

FIG. 15 is a flow diagram illustrating an example embodiment of a data mining service 1500. In one such embodiment, service 1500 may provide functionality such as sensor selection/grouping and reduction/deduplication, missing data/flat and peak/spike detection, and event refinement. In some embodiments, sensor reduction may be performed as a preprocessing step to remove sensors from consideration that have duplicative outputs. For example, when sensors are grouped according to type/physics, such as pressure or temperature, some sensors in each group may have duplicative outputs and thus may be potentially be omitted from one or more subsequent analysis steps. In other embodiments, sensor reduction may be applied via multiple iterations or passes, and may employ one or more models, e.g., statistical models, and/or domain-specific knowledge. Further, in yet other embodiments, peak/spike detection may include, for example, determining starting and ending points of data peak(s) and/or identifying time intervals with a greatest number of data output fluctuations. In some embodiments, event refinement may include, but is not limited to, adjusting or modifying a time interval for a given sensor reading, supplying data values for gaps in sensor readings, reconciling discrepancies between historical records of sensor outputs in numerical format and historical records of the sensor outputs in textual format, suppressing data values during time periods when an asset is known not to be operating, and conforming sensor data values to a predefined or preset floor/minimum, ceiling/maximum, and/or change range, among other examples. In other embodiments, separate databases may be used to store historical records of sensor outputs in numerical format and historical records of the sensor outputs in textual format.

In an example embodiment, as shown in FIG. 15, service 1500 may perform a data transfer 1501. According to an embodiment, data being transferred may be provided or supplied by user(s)/customer(s) 1502. Further, in one such embodiment, data being transferred may include, for example, raw data and/or information about a condition of the data 1503.

Continuing with FIG. 15, according to an example embodiment, service 1500 may further perform sensor auditing 1504. In one such embodiment, sensor auditing 1504 may include, e.g., missing sensor data analysis 1505, sensor data clustering 1506, sensor redundancy analysis 1507 (which may include, e.g., sensor reduction/deduplication, described in more detail herein), and/or sensor data conditioning 1508 (which may include, e.g., event refinement, described in more detail herein).

Again with respect to FIG. 15, according to an embodiment, service 1500 may also perform “Type I” data mining 1509. In an embodiment, data mining 1509 may include, e.g., frozen sensor (e.g., sensor missing data) analysis 1510, transition spike analysis 1511, and/or sensor seasonality analysis 1512. Transition spike analysis 1511 may in turn include detection, identification, and/or analysis of a transition in a sensor output from a data spike to a stable value, or vice versa. For example, in a chemistry setting, adding a catalyst to a solution may cause a spike in activity, followed by a transition to a stable state. As a further example, in a chemical engineering setting, when controls of a system or asset are changed from one regime to another, certain operating parameters of the system or asset may spike immediately after the change, followed by leveling off into a steady state. According to an embodiment, a transition between a data spike and a stable value for a sensor output may occur during a relatively short period of time. Sensor seasonality analysis 1512 may be applied to sensors with a long oscillation wavelength (e.g., a low oscillation frequency) and may include identifying and/or grouping sensor data outputs into different time intervals or “seasons.”

Further discussing FIG. 15, according to another embodiment, service 1500 may additionally or alternately perform “Type II” data mining 1513. In yet another embodiment, data mining 1513 may include, e.g., asset operating state analysis 1514, asset failure detection 1515, and/or asset failure duration measurement 1516.

Lastly with respect to FIG. 15, according to an example embodiment, service 1500 may provide 1517 users/customers 1502 with results from, e.g., data mining 1509 and/or 1513. In one such embodiment, provided results 1517 may be used for tasks such as auditing the results and preparing training data, among other examples.

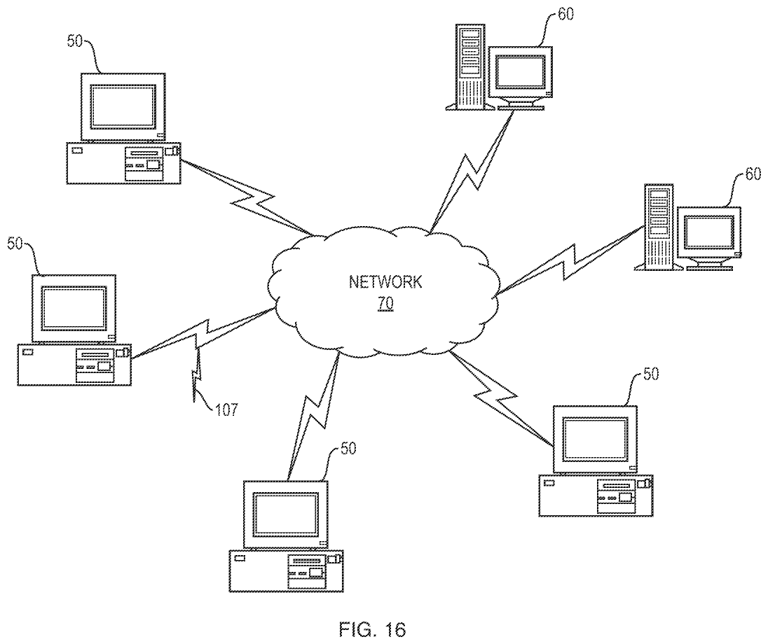

FIG. 16 is a schematic view of a computer network in which embodiments may be implemented.

Client computer(s)/devices 50 and server computer(s) 60 provide processing, storage, and input/output (I/O) devices executing application programs and the like. Client computer(s)/device(s) 50 can also be linked through communications network 70 to other computing devices, including other client device(s)/processor(s) 50 and server computer(s) 60. Communications network 70 can be part of a remote access network, a global network (e.g., the Internet), cloud computing servers or service, a worldwide collection of computers, local area or wide area networks, and gateways that currently use respective protocols (TCP/IP (Transmission Control Protocol/Internet Protocol), Bluetooth®, etc.) to communicate with one another. Other electronic device/computer network architectures are suitable.

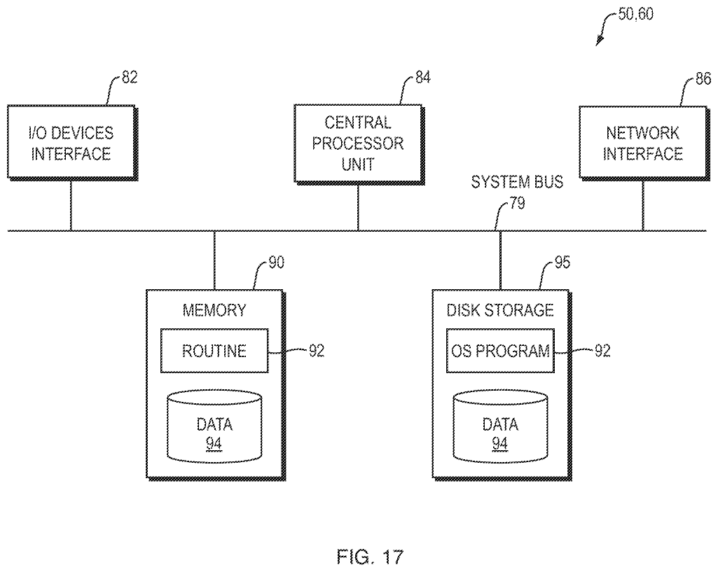

FIG. 17 is a block diagram illustrating an example embodiment of a computer node (e.g., client processor(s)/device(s) 50 or server computer(s) 60) in the computer network of FIG. 16. Each computer node 50, 60 contains system bus 79, where a bus is a set of hardware lines used for data transfer among components of a computer or processing system. Bus 79 is essentially a shared conduit that connects different elements of a computer system (e.g., processor, disk storage, memory, I/O ports, network ports, etc.) that enables transfer of information between the elements. Attached to system bus 79 is I/O device interface 82 for connecting various input and output devices (e.g., keyboard, mouse, display(s), printer(s), speaker(s), etc.) to the computer node 50, 60. Network interface 86 allows the computer node to connect to various other devices attached to a network (e.g., network 70 of FIG. 16). Memory 90 provides volatile storage for computer software instructions 92 and data 94 used to implement an embodiment of the present disclosure (e.g., the physical asset operating state analysis, sensor selection, sensor data selection, and data mining methods, processes, services, techniques, and program code detailed above in FIGS. 12-15). Disk storage 95 provides non-volatile storage for computer software instructions 92 and data 94 used to implement an embodiment of the present disclosure. Central processor unit 84 is also attached to system bus 79 and provides for execution of computer instructions.

In one embodiment, the processor routines 92 and data 94 are a computer program product (generally referenced as 92), including a computer readable medium (e.g., a removable storage medium such as DVD-ROM(s), CD-ROM(s), diskette(s), tape(s), etc.) that provides at least a portion of the software instructions for the disclosure system. Computer program product 92 can be installed by any suitable software installation procedure, as is well known in the art. In another embodiment, at least a portion of the software instructions may also be downloaded over a cable, communication, and/or wireless connection. In other embodiments, the disclosure programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present disclosure routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network (such as network 70 of FIG. 16). In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium, and the like.

In other embodiments, the program product 92 may be implemented as a so-called Software as a Service (SaaS), or other installation or communication supporting end-users.

While example embodiments have been particularly shown and described, it will be understood by those skilled in the art that various changes in form and details may be made therein without departing from the scope of the embodiments encompassed by the appended claims.

The teachings of all patents, published applications, and references cited herein are incorporated by reference in their entirety.

What is claimed is:

1. A computer-implemented method for analyzing an operating state of a physical asset, the method comprising:
acquiring, based on one or more predetermined criteria, data measurements from one or more preselected sensors configured to sense one or more respective aspects of the physical asset, the data measurements corresponding to one or more time periods, the one or more preselected sensors being preselected by correlating data measurements from a plurality of sensors of the physical asset to one or more operating states of the physical asset, the one or more predetermined criteria being predetermined by identifying one or more data output patterns of the one or more preselected sensors; and
determining, via a first model, one or more operating states of the physical asset based on the acquired data measurements.

2. The method of claim 1, wherein the first model comprises at least one of: a machine learning model, a dimensionality reduction model, and a clustering model.

3. The method of claim 2, wherein the clustering model comprises at least one of a statistical model and an analytical model.

4. The method of claim 2, wherein the dimensionality reduction model comprises at least one of: a principal component analysis (PCA) model, a restricted Boltzmann machine (RBM) model, a t-distributed stochastic neighbor embedding (t-SNE) model, and a uniform manifold approximation and projection (UMAP) model.

5. The method of claim 2, wherein the clustering model comprises at least one of: a self-organizing map (SOM) model, a mixture model, a local outlier factor (LOF) model, and a density-based model.

6. The method of claim 1, wherein:
the first model is configured, based on training data, with one or more operating state templates; and
determining, via the first model, the operating state of the physical asset based on the acquired data measurements comprises correlating the acquired data measurements with one of the one or more operating state templates.

7. The method of claim 6, wherein:
the training data includes domain-specific information; and
at least one of the one or more operating state templates is based, at least in part, on the domain-specific information.

8. The method of claim 1, further comprising:
generating, via the first model, one or more metrics, each of the metrics configured to measure a respective operating state of the determined one or more operating states; and
analyzing, via a second model, the determined one or more operating states based on the generated one or more metrics.

9. The method of claim 8, wherein the second model comprises at least one of: a machine learning model, a statistical distribution model, a polynomial decomposition model, a pattern matching model, a numerical similarity model, and an entropy model.

10. The method of claim 8, wherein analyzing the determined one or more operating states comprises identifying at least one of: (i) one or more boundaries of the determined one or more operating states, (ii) one or more durations of the determined one or more operating states, (iii) one or more patterns of the determined one or more operating states, (iv) one or more key sensors of the determined one or more operating states, (v) one or more features of the determined one or more operating states, and (vi) one or more indices of the determined one or more operating states.

11. The method of claim 10, further comprising:
generating one or more human-readable outputs corresponding to the identified one or more patterns of the determined one or more operating states.

12. A computer-implemented method for selecting a set of sensors of physical assets, the method comprising:
receiving sensor data from a plurality of physical assets, the sensor data collected from a plurality of sensors of the physical assets over multiple time periods;
receiving annotations representing an operating state of each of the plurality of physical assets at each of the multiple time periods; and
selecting a set of the plurality of sensors of the physical assets based on changes in operating states correlated with changes in the sensor data.

13. The method of claim 12, further comprising:
correlating the changes in operating states to the changes in the sensor data by analyzing the sensor data at the multiple time periods.

14. The method of claim 13, wherein correlating the changes in operating states to the changes in the sensor data by analyzing the sensor data at the multiple time periods comprises using a first model.

15. The method of claim 14, wherein the first model comprises at least one of: a machine learning model, an oscillation frequency model, a signal-to-noise ratio (SNR) model, a sensor physics model, and a sensor type-based model.

16. A computer-implemented method for determining criteria for acquiring data from sensors of physical assets, the method comprising:
receiving annotations representing a set of preselected sensors of a plurality of physical assets, the preselected sensors being preselected by correlating changes in sensor data collected over multiple time periods from a plurality of sensors of the plurality of physical assets to changes in operating states of the plurality of physical assets; and
determining criteria for acquiring data from the set of preselected sensors by identifying one or more data output patterns of the set of preselected sensors.

17. The method of claim 16, wherein identifying the one or more data output patterns of the set of preselected sensors comprises using a first model.

18. The method of claim 17, wherein the first model comprises at least one of: a missing data index model, a peak analysis model, and a frequency change model.

19. The method of claim 16, wherein identifying the one or more data output patterns of the set of preselected sensors comprises assigning output data of the set of preselected sensors to one or more categories.

20. The method of claim 19, wherein the one or more categories comprise one or more of: a stable state, a transition state, and a recovering state.
